(19) United States
(12) Patent Application Publication
(10) Pub. No.: US 2011/0132703 A1
(43) Pub. Date: Jun. 9, 2011

(54) HYBRID BRAKE SYSTEM

(75) Inventors: Hong Ki Kim, Gyeonggi-do (KR); Chang Bok Ko, Kyungki-Do (KR); Seung Hyup Bae, Chungnam (KR)

(73) Assignee: MANDO CORPORATION

(21) Appl. No.: 12/956,472

(22) Filed: Nov. 30, 2010

(30) Foreign Application Priority Data
Dec. 1, 2009 (KR) 10-2009-117616

(51) Int. Cl. B60T 11/22; B60T 7/04

(52) U.S. Cl. 188/152

(57) ABSTRACT

Disclosed is a hybrid brake system to perform a braking operation for a vehicle by generating hydraulic pressure in a master cylinder. The hybrid brake system includes an input shaft, a pedal simulator connected to the input shaft, a master cylinder provided therein with first and second pistons, an oil supply part supplying oil to the pedal simulator and the master cylinder, a power piston connected to the first piston, and a first chamber formed between the power piston and an inner surface of the master cylinder. The pedal simulator includes a simulation housing, a simulation rod provided at one end of the simulation housing, a second chamber formed at a lateral side of the first chamber to receive the simulation rod, and a boosting part communicated with the second chamber to generate the repulsive force as the brake pedal is pressed.

This application claims the benefit of Korean Patent Application No. 10-2009-0117616 filed on Dec. 01, 2009, in the Korean Intellectual Property Office, the disclosure of which is incorporated herein by reference.

### BACKGROUND

1. Field

The disclosure relates to a hybrid brake system. More particularly, the disclosure relates to a hybrid brake system to perform a braking operation for a vehicle by generating hydraulic pressure in a master cylinder.

2. Description of the Related Art

In general, when a driver steps on a brake pedal, a hydraulic active booster (HAB) detects displacement of the brake pedal from a pedal displacement sensor and closes a shut-off valve to close a fluid path between a master cylinder of a pedal simulator and a wheel, and an electronic control unit (ECU) calculates wheel pressure according to a pressure signal of a pressure sensor to control pressure of each wheel through an independent feedback control.

When the HAB fails, the shut-off valve is switched into a normally open (NO) state, so liquid pressure of the master cylinder corresponding to pedal force of the driver is transferred to a wheel cylinder so that the braking operation can be performed upon the system failure.

In such a HAB, if the driver steps on the brake pedal, an input shaft is moved and the ECU detects the movement of the input shaft, so fluid stored in an accumulator is transferred to the master cylinder to generate the liquid pressure in the master cylinder. However, if the pressure of the master cylinder is changed during the regenerative braking operation, the pressure variation may be transferred to the brake pedal, thereby deteriorating the pedal feeling.

### SUMMARY

Accordingly, it is an aspect of the disclosure to provide a hybrid brake system having a dual pedal simulator to improve the brake pedal feeling.

Additional aspects and/or advantages of the disclosure will be set forth in part in the description which follows and, in part, will be apparent from the description, or may be learned by practice of the disclosure.

The foregoing and/or other aspects of the disclosure are achieved by providing a hybrid brake system including an input shaft connected to a brake pedal, a pedal simulator connected to the input shaft to generate a repulsive force as the brake pedal is pressed, a master cylinder connected to the pedal simulator and provided therein with first and second pistons, an oil supply part supplying oil to the pedal simulator and the master cylinder, a power piston connected to the first piston and moved forward by receiving pressing pressure of the brake pedal through the input shaft, and a first chamber formed between the power piston and an inner surface of the master cylinder to form liquid pressure by receiving oil from the oil supply part. The pedal simulator includes a simulation housing, a simulation rod provided at one end of the simulation housing and connected to the input shaft, a second chamber formed at a lateral side of the first chamber to receive the simulation rod, and a boosting part communicated with the second chamber to generate the repulsive force as the brake pedal is pressed.

According to the disclosure, the simulation rod includes a first simulation rod provided at one side about the first chamber and a second simulation rod provided at on opposite side about the first chamber, and a bar is provided between the simulation rod and the input shaft to press the power piston.

According to the disclosure, the first and second simulation rods are integrally coupled with each other by the bar, and a gap is formed between a rear end of the power piston and the bar.

According to the disclosure, the boosting part includes a bore section communicated with the second chamber, a simulation piston slidably moved up and down in the bore section, a compression spring compressed by the simulation piston, and a housing cap supporting the compression spring.

According to the disclosure, a damping hole is formed at a lower end of the simulation piston, and a damping protrusion is provided at the housing cap so as to be inserted into the damping hole.

According to the disclosure, the simulation housing is formed with an oil port to supply oil into the first chamber.

As described above, according to one aspect of the disclosure, the simulation rods are provided at both sides of the first chamber so that the size of the hybrid brake system can be reduced.

In addition, the hydraulic pressure can be independently controlled by the pedal simulator having the parallel structure, so that the brake pedal feeling can be improved.

Further, since the pedal simulator is installed separately from the housing, the hybrid brake system can be variously designed and the tuning of the hybrid brake system may be easy.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a perspective view schematically showing a hybrid brake system according to the disclosure;

FIG. 2 is a sectional view schematically showing a hybrid brake system according to the disclosure;

FIG. 3 is a partially enlarged sectional view schematically showing a hybrid brake system according to the disclosure;

FIG. 4 is a partial perspective view schematically showing a pedal simulator of a hybrid brake system according to the disclosure; and

FIG. 5 is a sectional view schematically showing a pedal simulator of a hybrid brake system according to the disclosure.

### DETAILED DESCRIPTION OF THE EXEMPLARY EMBODIMENTS

Reference will now be made in detail to the embodiments of the disclosure, examples of which are illustrated in the accompanying drawings, wherein like reference numerals refer to the like elements. The embodiments are described below to explain the disclosure by referring to the figures.

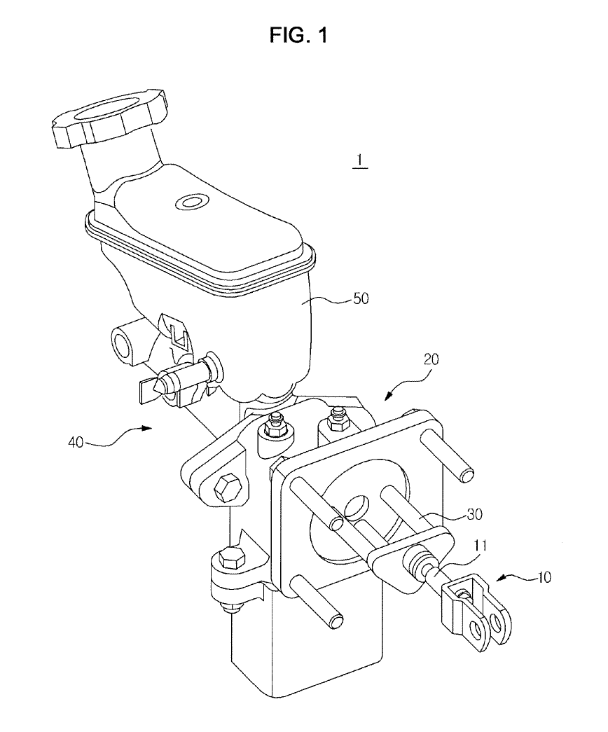

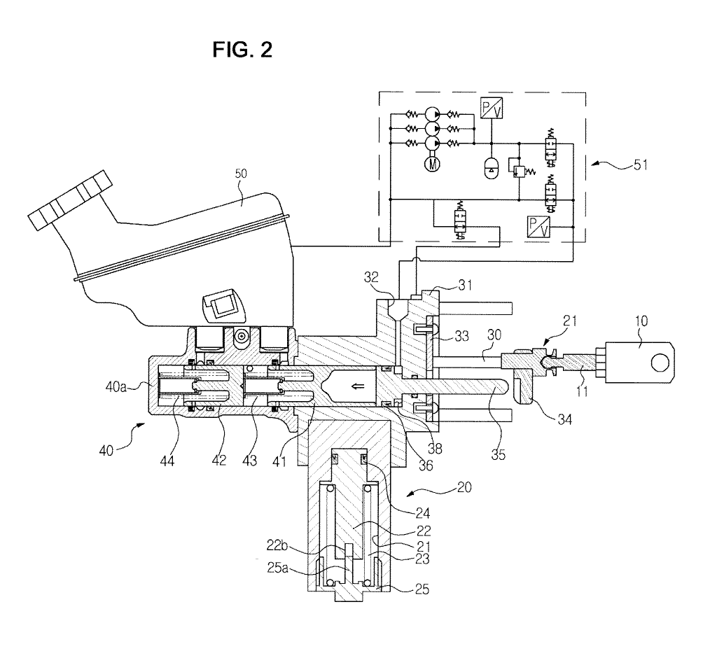

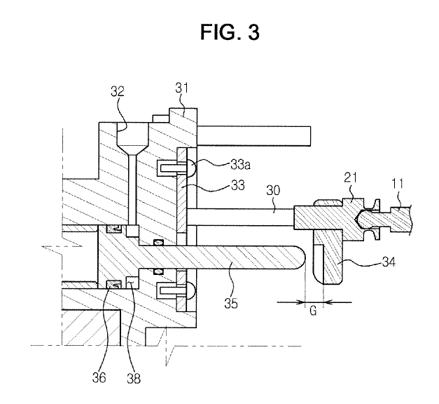

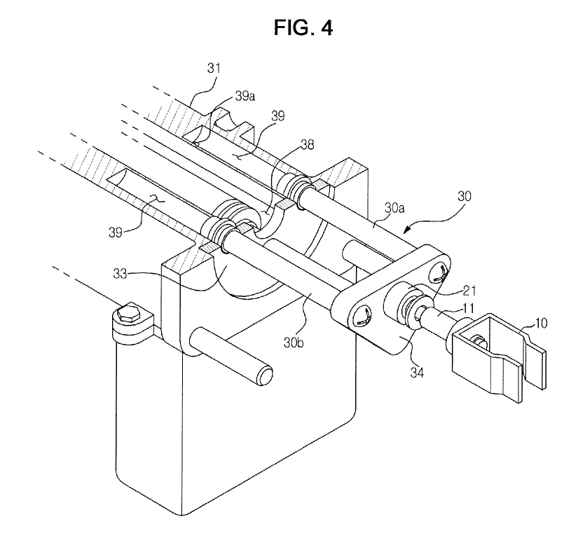

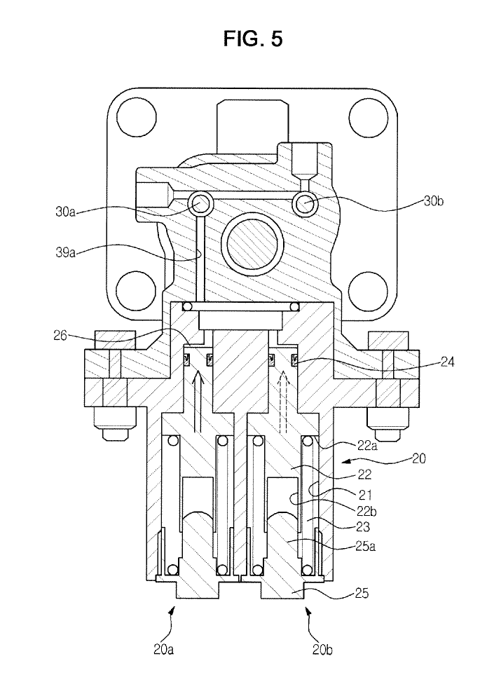

FIG. 1 is a perspective view schematically showing a hybrid brake system according to the disclosure, FIG. 2 is a sectional view schematically showing the hybrid brake system according to the disclosure, FIG. 3 is a partially enlarged sectional view schematically showing the hybrid brake system according to the disclosure, FIG. 4 is a partial perspective view schematically showing a pedal simulator of the hybrid brake system according to the disclosure, and FIG. 5 is a sectional view schematically showing the pedal simulator of the hybrid brake system according to the disclosure.

As shown in the drawings, the hybrid brake system 1 according to the embodiment of the disclosure includes a brake pedal 10 operated by a driver upon the braking operation, an input shaft 11 connected to the brake pedal 10, a pedal simulator 20 to provide repulsive force against the brake pedal 10, a master cylinder 40 connected to the pedal simulator 20 to transfer braking pressure to a wheel brake (not shown) as the braking pressure is generated by the brake pedal 10, a power piston 35 connected to the master cylinder 40 to move in the forward direction by receiving the pressure of the brake pedal 10 from the input shaft 11, an oil reservoir 30 to store oil therein, and an oil supply part 51 for supplying oil of the oil reservoir 30 to the master cylinder 40 and the pedal simulator 20.

One side of the input shaft 11 is connected to the brake pedal 10 and the other side of the input shaft 11 is connected to a control plunger 21 and a simulation rod 30 of the pedal simulator 20 connected to the control plunger 21, which will be described later in detail.

A bar 34 having a triangular shape is coupled to an outer portion of the control plunger 21, and the simulation rod 30 is installed at an upper portion of the bar 34.

The simulation rod 30 includes a first simulation rod 30a and a second simulation rod 30b. The first simulation rod 30a is fixed to one side of the upper portion of the bar 34 and the second simulation rod 30b is fixed to the other side of the upper portion of the bar 34.

That is, the first and second simulation rods 30a and 30b are spaced apart from each other by a predetermined distance, and a first chamber 38 is formed between the first and second simulation rods 30a and 30b, so that interference factors in the longitudinal direction may be removed, thereby maintaining the balance of force.

Reference numeral 33 is a disc to support the first and second simulation rods 30a and 30b to a simulation housing 31, and reference numeral 33a is a fastening member to fix the disc 44 to the simulation housing 31.

The master cylinder 40 includes a cylinder housing 40a having a space to store oil therein, and an oil reservoir 50 is coupled with the upper portion of the cylinder housing 40a.

One end of the cylinder housing 40a is open and coupled with the pedal simulator 20.

The cylinder housing 40a is provided therein with a first piston 41 moving forward by the power piston 35, a second piston 42 spaced apart from the first piston 41 by a predetermined distance, first and second springs 43 and 44 elastically support between the first and second pistons 41 and 42 and between the second piston 42 and the cylinder housing 40a, and the first chamber 38 formed between the inner wall of the cylinder housing 40a and the power piston 35 to store oil supplied from the oil reservoir 50.

A sealing member 36 is installed at an outer portion of a front end of the power piston 35 to seal between the outer portion of the power piston 35 and the inner wall of the cylinder housing 40a.

The front end of the power piston 35 is supported by the rear end of the first piston 41. Thus, the first piston 41 moves forward as the power piston 35 moves forward, and the second piston 42 moves forward by the first piston 41.

The pressing force of the brake pedal 10 is transferred to the power piston 35 through the bar 34 of the control plunger 21 connected to the input shaft so that the power piston 35 moves forward. A gap G is formed between the power piston 35 and the bar 34.

In the case of the normal operation, the force applied to the input shaft 11 and the control plunger 21 connected to the brake pedal 10 may not be transferred to the power piston 35 through the bar 34 due to the gap G.

In other words, in the case of the regenerative braking, even if the power piston 35 moves backward, the bar 34 of the control plunger 21 does not make direct contact with the power piston 35, so the pedal feeling of the brake pedal 10 is not deteriorated.

The pedal simulator 20 includes the simulation housing 31, the simulation rod 30 installed at one side of the simulation housing 31 and connected to the input shaft 11, second chambers 39 formed at both lateral sides of the first chamber 38 to receive the first and second simulation rods 30a and 30b therein, and a boosting part communicated with the second chamber 39 to generate the repulsive force as the brake pedal 10 is pressed.

An oil port 32 is formed at an upper portion of the simulation housing 31 to supply the oil from the oil reservoir 50 to the first chamber 38.

The first and second simulation rods 30a and 30b move back and forth in the second chambers 39 of the simulation housing 31. The second chambers 39 of the simulation housing 31 are spaced apart from each other while interposing the first chamber 38 therebetween, so that the size of the hybrid brake system can be reduced.

The boosting part having the parallel structure is installed at the lower portion of the simulation housing 31. The boosting part generates the repulsive force to improve the pedal feeing when the brake penal 10 is pressed.

The boosting part includes a bore section 21 having a third chamber 26 connected to the second chambers 39, a simulation piston 22 slidably moved up and down in the bore section 21, a compression spring 33 compressed by the simulation piston 22, and a housing cap 25 supporting the compression spring 33 and the simulation piston 22.

The third chamber 26 is formed between an inner upper portion of the bore section 21 and the upper end of the simulation piston 22 and the third chamber 26 is communicated with the second chambers 39.

In addition, the second chambers 39 are formed with simulation holes 39a to supply oil from the second chambers 39 to the second chambers 39.

The boosting part of the simulation housing 31 has the parallel structure and includes a first boosting part 20a located to the left of the boosting part and a second boosting part 20b located to the right of the boosting part.

The first and second boosting parts 20a and 20b can supply power independently from each other, so that the braking operation can be independently controlled.

The oil supply part 51 may include a motor M controlled by an electronic control unit (ECU; not shown), a pump M operated by the motor M, and an accumulator temporally storing high-pressure oil supplied from the pump P.

The motor M is controlled by the ECU (not shown). The ECU controls the motor M to setup the pressure corresponding to the pedal force of the driver detected by a pedal displacement sensor.

A pressure sensor (not shown) is provided at an outlet side of the accumulator to measure oil pressure of the accumulator. The ECU compares the oil pressure measured by the pressure sensor with preset oil pressure and drives the pump when the measured oil pressure is lower than the present oil pressure to fill the accumulator with oil.

In addition, the ECU supplies the oil filled in the accumulator to the first chamber 38 through the oil port 32 corresponding to the pedal force of the driver.

Thus, liquid pressure is generated between the power piston 35 and the first piston 41 due to the oil supplied to the first chamber 38.

The simulation piston 22 has a cylindrical shape and a flange 22a is provided at an outer portion of an upper end of the simulation piston 22. In addition, a damping hole 22b in formed at the center of a bottom surface of the simulation piston 22.

A sealing member 24 is provided at an upper portion of the simulation piston 22 to seal between the simulation piston 22 and the bore section 21.

The flange 22a of the simulation piston 22 has a size corresponding to an inner diameter of the bore section 21 and supports one side of the compression spring 33.

The housing cap 25 has a size corresponding to the inner diameter of the bore section 21 and installed at the lower end of the bore section 21. A damping protrusion 25a is provided at the center of the housing cap 25. The damping protrusion 25a protrudes upward so as to be inserted into the damping hole 22b of the simulation piston 22.

The damping hole 22b of the simulation piston 22 and the damping protrusion 25a of the housing cap 25 guide the movement of the simulation piston 22.

The compression spring 33 is installed between the flange 22a of the simulation piston 22 and the housing cap 25 to elastically support the simulation piston 22.

That is, as the brake pedal 10 is pressed, the simulation rod 30 moves forward, so that the oil is transferred from the second chambers 39 to the third chamber 26. Thus, the simulation piston 22 of the third chamber 26 moves down while compressing the compression spring 33. Therefore, the driver may feel improved pedal feel due to the repulsive force of the compression spring 33.

At this time, since the boosting part has the parallel structure, the boosting part can independently supply pressure to each chamber and the braking operation can be independently controlled.

The first and second boosting parts 20a and 20b have the same structure and same operation, so detailed description thereof will be omitted.

Although few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A hybrid brake system comprising:
an input shaft connected to a brake pedal;
a pedal simulator connected to the input shaft to generate a repulsive force as the brake pedal is pressed;
a master cylinder connected to the pedal simulator and provided therein with first and second pistons;
an oil supply part supplying oil to the pedal simulator and the master cylinder;
a power piston connected to the first piston and moved forward by receiving pressing pressure of the brake pedal through the input shaft; and
a first chamber formed between the power piston and an inner surface of the master cylinder to form liquid pressure by receiving oil from the oil supply part,
wherein the pedal simulator includes a simulation housing, a simulation rod provided at one end of the simulation housing and connected to the input shaft, a second chamber formed at a lateral side of the first chamber to receive the simulation rod, and a boosting part communicated with the second chamber to generate the repulsive force as the brake pedal is pressed.

2. The hybrid brake system of claim 1, wherein the simulation rod includes a first simulation rod provided at one side about the first chamber and a second simulation rod provided at on opposite side about the first chamber, and a bar is provided between the simulation rod and the input shaft to press the power piston.

3. The hybrid brake system of claim 2, wherein the first and second simulation rods are integrally coupled with each other by the bar, and a gap is formed between a rear end of the power piston and the bar.

4. The hybrid brake system of claim 1, wherein the boosting part includes a bore section communicated with the second chamber, a simulation piston slidably moved up and down in the bore section, a compression spring compressed by the simulation piston, and a housing cap supporting the compression spring.

5. The hybrid brake system of claim 4, wherein a damping hole is formed at a lower end of the simulation piston, and a damping protrusion is provided at the housing cap so as to be inserted into the damping hole.

6. The hybrid brake system of claim 1, wherein the simulation housing is formed with an oil port to supply oil into the first chamber.
